(19) United States
(12) Patent Application Publication
(10) Pub. No.: US 2005/0049908 A2
(43) Pub. Date: Mar. 3, 2005

(54) System for Influence Network Marketing

(75) Inventor: John W. Hawks, Sparks, MD (US)

Correspondence Address: VENABLE, BAETJER, HOWARD AND CIVILETTI, LLP, P.O. BOX 34385, WASHINGTON, DC, 20043-9998, US

(73) Assignee: COMSORT, Inc., Hunt Valley, MD (US)

(21) Appl. No.: 10/787,143

(22) Filed: Feb. 27, 2004

Related U.S. Application Data
(63) Continuation of application No. 09/386,353, filed on Aug. 31, 1999.

(51) Int. Cl. G06F 17/60

(52) U.S. Cl. 705/10

(57) ABSTRACT

Abstract of the Disclosure

An innovation is marketed to members in a target community. An influence network is determined for the members in the target community, and the opinion leaders are identified from among the members using the influence network. The innovation is presented to the opinion leaders, and assistance is provided with the dispersion of evaluations of the innovation from opinion leaders to the members in the target community by using the influence network.

### Detailed Description of the Invention

### BACKGROUND OF THE INVENTION

Cross-Reference to Related Applications

This application is a continuation of application Serial No. 09/386,353 filed August 31, 1999, which is incorporated herein by reference.

Field of the Invention

The invention relates to a system for marketing and, more particularly, to a system for marketing an innovation using opinion leaders and an influence network.

Background of the Invention

Conventional marketing strategies and techniques for selling new products and services use mass marketing. Large inefficiencies and costs are incurred when new products and services are marketed to a small segment of the population, such as those identified by a specific geographic area and/or a specific occupation or profession. If more personal levels of communication are employed, such as by direct contact with each potential customer by salespeople, the costs of marketing typically increase dramatically. Further, the speed with which the new product or service is adopted or not adopted is often very slow, despite the large mass marketing efforts employed.

For example, in the United States today, over 10 billion dollars is spent annually in marketing new healthcare products and services to physicians. This huge sum of money is spent to influence a group of only approximately 300,000 members. Such a large amount of money is needed to market the new healthcare products and services to physicians because conventional marketing techniques are employed by the manufacturers and advertisers.

To disseminate information on a new healthcare product, such as a new drug, much energy and cost is expended in persuading a physician to prescribe the new drug. Initially, literature and samples are typically sent to every physician who might prescribe the new drug. Each physician may also receive one or more office visits from a salesperson for the manufacturer of the new drug. The salesperson attempts to persuade the physician to prescribe the new drug. However, by itself, the pitch by the salesperson is typically unsuccessful in persuading the physician to prescribe the new drug.

Further, the final decision by the physicians to adopt (i.e., prescribe) or not adopt (i.e., not prescribe) the new drug typically involves a slow proces, and great effort and expense are incurred by the drug manufacturer in attempting to persuade the physicians to prescribe the new drug. A more efficient marketing system is needed to bring about an earlier final decision by the physicians to adopt or not adopt the new drug. With an earlier decision to adopt the new drug, marketing efforts and expenses would be saved because the marketing campaign could be ended earlier. With an earlier decision not to adopt the new drug, the drug manufacturer would cease the marketing campaign, evaluate the reasons why the new drug was not adopted, and either respond to the reasons or cease selling the new drug. For either case of earlier adoption or earlier non-adoption, the drug manufacturer would realize savings in marketing effort and expense.

There exists a need to reduce the costs of marketing to potential customers, especially in focused markets, such as healthcare. Further, there exists a need for efficient marketing of new products and services to potential customers. Moreover, there exists a need to have an earlier adoption or non-adoption of a new product or service by potential customers.

### SUMMARY OF THE INVENTION

An object of the invention is to reduce the costs and increase the efficiency of marketing a new product or service to potential customers, especially in focused markets, such as marketing new healthcare products and services to healthcare providers.

An object of the invention is to have an earlier adoption or non-adoption of a new product or service by potential customers.

An object of the invention is to provide a technique for marketing innovations to a target group of potential customers.

The invention includes a method, an apparatus, and an article of manufacture for influence network marketing.

The method of the invention includes a method for marketing an innovation to members in a target community. An influence network is determined for the members in the target community, and the opinion leaders are identified from among the members using the influence network. The innovation is presented to the opinion leaders, and assistance is provided with the dispersion of evaluations of the innovation from opinion leaders to the members in the target community by using the influence network.

The apparatus of the invention includes a computer having software to operate the computer in accordance with the invention.

The article of manufacture of the invention includes a computer-readable medium having software to operate a computer in accordance with the invention.

The article of manufacture of the invention includes an information storage device embodying a mapping of the influence network for use with the invention.

The above objects and advantages of the invention are illustrative, and not exhaustive, of those which can be achieved by the invention. Thus, these and other objects and advantages of the invention will be apparent from the description herein or can be learned from practicing the invention, both as embodied herein and as modified in view of any variations which will be apparent to those skilled in the art.

### BRIEF DESCRIPTION OF THE DRAWINGS

Embodiments of the invention are explained in greater detail by way of the drawings, where the same reference numerals refer to the same features.

Figure 1 illustrates a flow diagram for marketing an innovation to members in a target community using opinion leaders and an influence network.

Figure 2 illustrates a flow diagram for determining the influence network for the members in a target community.

Figure 3 illustrates a sociogram of a first technical advice network.

Figure 4 illustrates a sociogram of a second technical advice network.

Figure 5 illustrates a sociogram of a trust and friendship network.

Figure 6 illustrates a sociogram of an influence network.

### DETAILED DESCRIPTION OF THE INVENTION

The description of the invention is segmented into a section on definitions and a section on marketing using influence networks. All examples described herein are non-limiting examples.

### Definitions

“Diffusion” refers to the process by which information on an innovation is communicated through communication channels over time among members of a targeted community.

“Innovation” refers to a new or improved product or service, which may or may not be patentable. Examples of an innovation include a new drug, a new medical device, new medical testing equipment, a quality improvement program for a group of physicians or a hospital, a new insurance program, a new agricultural product, a new agricultural device, an educational tool, and a new consumer product.

“Target community” refers to a group identified by a change agent, where the change agent desires to have the identified group adopt an innovation. For example, a target community is the group of physicians in a particular geographic locale or medical specialty, such as the psychiatrists practicing in southern Florida and identified by a change agent for a drug manufacturer of new drugs. A target community is composed of members, where a “member” refers to one or more members and/or one or more organizations.

The structure of a target community (i.e., the pattern of relationships between the members of the target community) is a major factor in the success and rate of diffusion. This structure underlies the predictability of behavior among the members of the target community. The structure of a target community is divided into two categories: the social structure and the communication structure.

The “social structure” of a target community refers to the hierarchical arrangement of the members of the target community. This hierarchy dictates who will influence whom within the target community. The influence can be direct, such as a bureaucratic chain of command, or indirect, such as the influence of a role model or a prominent professional.

The “communication structure” of a target community refers to the network of interaction within the target community. The communication structure determines who interacts with whom within the target community and under what circumstances. The communication structure operates on the principle that most members talk with others who are similar to themselves and therefore tend to aggregate into identifiable subgroups.

“System norms” of a target community refer to the set of established behavior patterns that serve as a guide or standard for the members of the target community. System norms are major factors in the rate of adoption and the probability of adoption of an innovation within the target community. Further, system norms determine the compatibility of an innovation with what is currently in use within the target community. System norms manifest as scientific paradigms, cultural mores, professional ethics and standards, corporate policy, and so forth.

An “opinion leader” refers a member in a target community who has influence over the attitudes and/or the behavior of other members in the target community. Opinion leaders are generally more exposed to all forms of external communication, are more cosmopolitan, and have somewhat higher social or professional status. Opinion leaders also tend to be more innovative than their peers but are usually not the trailblazers or earliest adopters of an innovation. In addition, opinion leaders are at the center of interpersonal communication networks, and the behavior of opinion leaders is accessible to and imitated by other members of the target community.

A “change agent” refers to one or more members outside of a target community who seek to have an innovation adopted by the members of the target community. Although outside of the target community, a change agent possesses both the technical information and communication skills necessary to persuade members of the target community to adopt the innovation. For example, a change agent is one or more salespeople representing a manufacturer of an innovation. For instance, if the target community is physicians, if the innovation is a new drug, and if the change agent is one or more salespeople for the manufacture of the new drug, the change agent desires to persuade the physicians to use the new drug by prescribing the new drug for the patients of the physicians.

“Adoption” of an innovation by a target community or by a member of a target community refers to a decision to make full use of an innovation or initiate a trial of an innovation. “Non-adoption” of an innovation by a target community or by a member of a target community occurs when an innovation is not adopted. The social structure of a target community affects the decision-making used in the adoption of an innovation. The types decisions made during the decision-making of adoption are categorized as three types: optional innovation decisions, collective innovation decisions, and authority innovation decisions.

An “optional innovation decision” refers to an adoption choice made by a member in a target community independent of the decisions of the peers of the member as to whether to adopt or not adopt an innovation. While system norms and input from other members usually influence this type of decision, the choice is a personal one for the member.

A “collective innovation decision” refers to an adoption choice made by a consensus within a target community as to whether to adopt or not adopt an innovation. Once this type of decision is made, the consequences affect all members of the target community.

An “authority innovation decision” refers to an adoption choice made by a few members of a target community who possess power, status, or technical expertise as to whether to adopt or not adopt an innovation.

Authority and collective innovation decisions are most common in formal target communities, such as schools, businesses, and government agencies, and optional innovation decisions are most common in informal target communities, such as healthcare, agriculture, and consumer target communities. Authority innovation decisions often involve the most rapid rates of adoption but are frequently circumvented during their implementation. Conversely, optional innovation decisions are often the slowest way to adoption but result in more concrete results.

A “communication channel” refers to the path of information flow between and among the members of a target community. Two types of communication channels are mass media communication channels and interpersonal communication channels.

“Mass media communication channels” refer to any manner of transmitting information through a mass medium, such as radio, television, journals, and newspapers. Mass media communication channels provide rapid and efficient delivery of information, but often lack the credibility and trustworthiness of interpersonal communication channels.

“Interpersonal communication channels” refer to the exchange of information between two or more members of a target community. Examples of interpersonal communication channels include the exchange of information using: personal meetings and visits; telephone calls; letters; and electronic mail. While interpersonal communication channels are slower than mass media communication channels, interpersonal communication channels are often more effective. Interpersonal communication channels are often used to implement the communication structure of a target community.

“Homophily” refers to the extent to which members in a target community are similar in attributes, such as beliefs, education, religion, and profession. These attributes often connote similarities in working and living environments, personal interests, and sub-cultural language. Communication between homophilous members in a target community is often more empathetic, effective, and rewarding than communication between non-homophilous members in the target community.

An “influence network” refers to a mapping of the social structure and the communication structure of a target community. The influence network identifies opinion leaders in the target community and identifies which members in the target community influence other members in the target community. Influence is typically determined by homophilous relationships between members. An influence network can be separated into sub-networks.

The “innovation decision process” refers to the decision process a member of a target community, or a target community itself, undergoes to reach a final decision as to whether to use or not use an innovation continually. The innovation decision process has four steps: (1) awareness, (2) agreement/rejection, (3) adoption, and (4) integration and adherence. First, in the awareness step, a member becomes initially aware of the existence of the innovation and how the innovation functions. Second, in the agreement/rejection step, the member makes an initial decision to agree to use the innovation or reject the use of the innovation. Third, in the adoption step, the member makes a decision to adopt or not adopt the innovation. Fourth, in the integration and adherence step, the member integrates the decision to either adopt or not adopt the innovation into the day-to-day practice of the member and adheres to the decision on a day-to-day basis.

The key element in each of the four steps of the innovation decision process is information. A member seeks information in the innovation decision process to decrease the amount of uncertainty regarding the advantages, disadvantages, and expected consequences of the innovation. As information is made available through communication channels, the potential for more rapid and effective diffusion increases.

“Innovativeness” refers to the degree to which a member in a target community is likely to adopt an innovation more quickly than the other members in the target community. Members in a target community are divided into five categories according to their innovativeness, and these five categories are, in order of decreasing innovativeness: innovators, early adopters, early majority, late majority and laggards. Innovators are those members who are the quickest to adopt an innovation, and laggards are those members who are the slowest to adopt an innovation.

The “rate of adoption” refers to the relative speed with which the members of a target community adopt an innovation. In general, at first, only a few members, namely the innovators, adopt an innovation. The rate of adoption then begins to increase as members gain more knowledge about the innovation and learn of its adoption by innovators. As fewer people are left who have not yet adopted the innovation, namely the late majority and laggards, the rate of adoption begins to decrease. Eventually, when the laggards have adopted the innovation, the rate of adoption drops to zero, and the diffusion of the innovation is complete.

A "computer" refers to any apparatus that is capable of accepting a structured input, processing the structured input according to prescribed rules, and producing results of the processing as output. Examples of a computer include: a computer; a general purpose computer; a supercomputer; a mainframe; a super mini-computer; a mini-computer; a workstation; a micro-computer; a personal computer (PC); a serial-processing computer; a parallel-processing computer; a server; an interactive television; and a hybrid combination of a computer and an interactive television. A computer also refers to two or more computers connected together via a network for transmitting or receiving information between the computers. An example of such a computer includes a distributed computer system for processing information via computers linked by a network.

A "computer-readable medium" refers to any storage device used for storing data accessible by a computer. Examples of a computer-readable medium include: a magnetic hard disk; a floppy disk; an optical disk, such as a CD-ROM; a magnetic tape; a memory chip; and a carrier wave used to carry computer-readable electronic data, such as those used in transmitting and receiving e-mail or in accessing a network.

"Software" refers to prescribed rules to operate a computer. Examples of software include: software; code segments; instructions; computer programs; and programmed logic.

A "network" refers to a number of computers and associated devices that are connected by communication facilities. A network involves permanent connections such as cables or temporary connections such as those made through telephone or other communication links. Examples of a network include: the Internet; a local area network (LAN); and a wide area network (WAN).

An “information storage device” refers to an article of manufacture used to store information. An information storage device can have different forms, for example, paper form and electronic form. In paper form, the information storage device comprises paper printed with the information. In electronic form, the information storage device comprises a computer-readable medium storing the information.

### Marketing Using Influence Networks

With the invention, a change agent is able to diffuse an innovation efficiently, cost effectively, and quickly to the members of a target community using a map of the influence network of the target community, known as a sociogram. The change agent identifies and categorizes the interpersonal communication channels in the target community and efficiently disseminates information on the innovation using the communication structure identified by the influence network for the target community. With the invention, the change agent can bring about a swift, efficient, and less expensive adoption or non-adoption of an innovation, as compared to the conventional marketing techniques.

With the invention, a change agent surveys, analyzes, maps, and uses the influence network that already exists in a target community. With a survey, the change agent collects information about the social structure and the communication structure in the target community. From analyzing the survey, the change agent identifies the influence network and develops sociograms for the influence network. For the change agent, the sociograms for a target community indicate which members communicate with which other members and indicate which members influence which other members. Further, the sociograms visually present the influence network in an easily understandable format for the change agent and assist the change agent in understanding how innovations are adopted or not adopted in the target community. The change agent bases the marketing effort for the innovation on the influence network and focuses significant resources on persuading those members who are opinion leaders in the target community. The opinion leaders are important to the change agent because the opinion leaders are conduits for efficiently disseminating evaluations on the innovation throughout the target community. Early adoption or non-adoption by the opinion leaders results in faster and efficient adoption or non-adoption of the innovation throughout the target community. Moreover, the ability of the change agent to understand the influence network and employ the existing social structure and communication structure identified by the influence network is critical for fast, efficient, and cost effective adoption of an innovation.

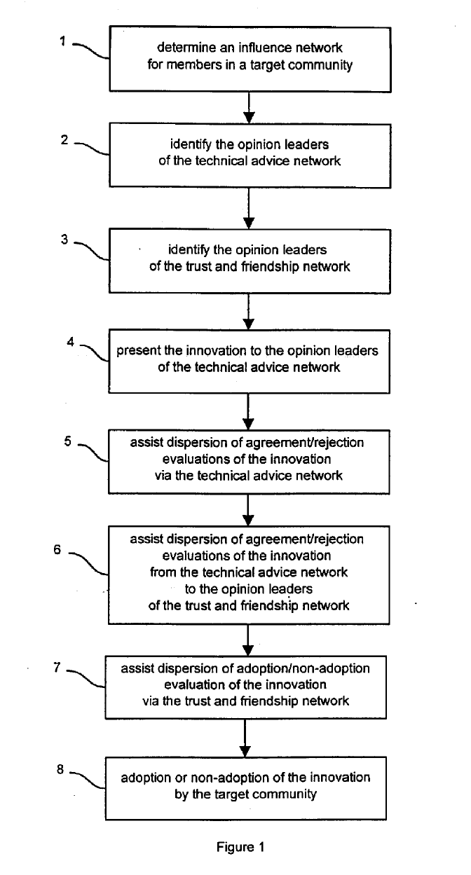

Figure 1 illustrates a flow diagram for marketing an innovation to members in a target community using opinion leaders and an influence network. A change agent is desirous of having a target community adopt an innovation, and with the invention, the change agent is able to efficiently, cost effectively, and quickly do so. The invention provides an efficient scheme for use by the change agent to disseminate evaluations of the innovation to obtain a quick adoption or non-adoption of the innovation.

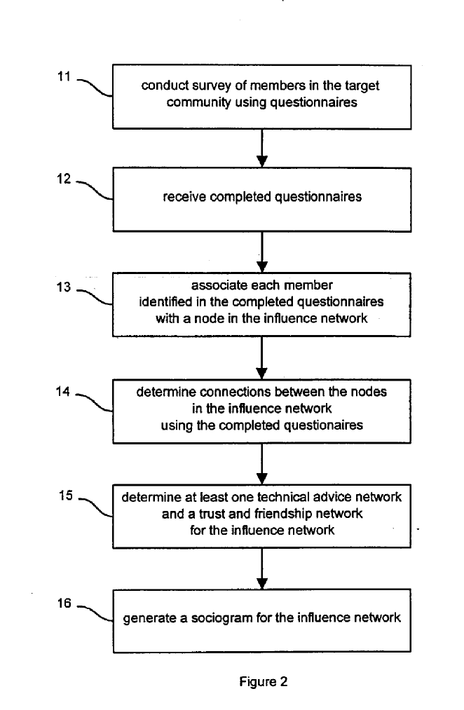

In block 1, the influence network is determined for the members in the target community. The target community is defined, the members in the target community are identified, and the influence network is determined. With the influence network from block 1, a change agent can diffuse information on an innovation to the target community. Block 1 is implemented using the flow diagram of Figure 2.

Figure 2 illustrates a flow diagram for determining the influence network for the members in the target community. In block 11, a survey of the members in the target community is conducted by providing questionnaires to the members in the target community. The questionnaire is embodied on an information storage device and is distributed by any of several survey mechanisms. Examples of survey mechanisms include: mass mailings seeking voluntary responses from the members in the target community; targeted mailings to existing clients of the change agent, where the existing clients are members in the target community; focused distributions through trade and/or professional periodicals or at trade and/or professional forums; and personal meetings or telephone calls to members in the target community. The survey mechanism can use, for example, the postal services or electronic mail services.

The questionnaire seeks to determine which members in the target community influence the respondent to the questionnaire, and/or which members in the target community are influenced by the respondent to the questionnaire. The questionnaire is designed to solicit responses about who the respondent talks to about innovations in the target community, who the respondent looks to for guidance on technical matters, and who the respondent trusts in the target community. For example, the questionnaire asks questions such as: “From whom do you seek technical advice in the target community?”; “Whom do you socialize with or trust in the target community?”; or “Who is an international, national, or regional leader in a technical field of the target community, whose writings you read or lectures you attend, but with whom you do not necessarily communicate?”.

In block 12, the completed questionnaires are received from the members in the target community responding to the questionnaires. The completed questionnaires identify the members in the target community that influence or are influenced by the respondent. For example, in response to the question “From whom do you seek technical advice in the target community?”, a respondent identifies a number of members in the target community whose technical knowledge and skills are respected by the respondent and who are available to the respondent for giving technical advice.

Ideally, a questionnaire is received from each member in the target community. However, more likely, questionnaires are received from not all members in the target community. The completed questionnaires are examined to determine additional members to be recipients of the questionnaire. Newly identified members are determined from the members named in each received questionnaire. If it is decided that more responses are needed, additional questionnaires are distributed to the newly identified members. This process continues until a sufficiently large sampling of the members in the target community is obtained to map the influence network of the target community. In general, responses from approximately 4% to approximately 30% of the members in the target community are sufficient to map the influence network of the target community.

In blocks 13-16, the completed questionnaires are analyzed, and the influence network is determined. In block 13, each member that is listed in the completed questionnaires is identified and is associated with a node in the influence network. In the influence network, the members in the network are identified by names or by symbols, such as numbers, letters, or alpha-numerics.

As an example, if in response to the question “Whom do you socialize with or trust in the target community?”, a first respondent, Alexis, lists Bob, Calvin, and Diane, the influence network has at least four nodes, one for each of the members, Alexis, Bob, Calvin, and Diane. The influence network has at least four nodes because additional nodes may be needed depending on the responses in the remaining completed questionnaires, which may list more members in the target community.

In block 14, the connections between the nodes in the influence network are determined using the completed questionnaires. The completed questionnaires provide the relationships between the members in the target community. The connections in the influence network identify the types of relationships between the members in the target community. If no connection is made between two nodes in the influence network, there is no social structure or communication structure between the two members represented by the two nodes. The connections between the nodes are determined from the responses in the completed questionnaires.

In a completed questionnaire, the respondent lists those members that influence the respondent or any members that the respondent influences. The flow of influence from (or to) the named members in a questionnaire to (or from) the respondent of the questionnaire is represented in the influence network as a connection from (or to) the respondent to (or from) the named members.

Continuing the above example, if in response to the question “Whom do you socialize with or trust in the target community?,” a first respondent, Alexis, lists Bob, Calvin, and Diane, connections are made between the nodes for Alexis and Bob, Alexis and Calvin, and Alexis and Diane. Further, the flow of the influence from Bob, Calvin, and Diane to Alexis is identified by the connections in the influence network.

In block 15, at least one technical advice network and a trust and friendship network are determined for the influence network. The influence network has at least two sub-networks: at least one technical advice network and a trust and friendship network. As an option, the influence network has at least one technical advice network and at least one trust and friendship network.

The technical advice network identifies the social structure and the communication structure in the target community that the members use for obtaining evaluations on whether to agree with or reject an innovation. The technical advice network identifies the flow in the target community of evaluations on a technical subject related to the target community. The technical advice network maps how evaluations of the technical merits of an innovation are transmitted through the target community. For instance, a member in the target community relies upon a first subset of the members in the target community for evaluations of a first technical subject and a second subset of the members in the target community for evaluations of a second technical subject, but does not rely on a third subset of the members in the target community for evaluations of either technical subject. The first and second subsets may or may not be overlapping.

As an example, for a target community of psychiatrists, a first technical advice network is determined for the technical subject of depression, and a second technical advice network is determined for the technical subject of schizophrenia. The first and second technical advice networks are most likely different; however, they may be the same. A psychiatrist relies on a first subset of the psychiatrists for evaluations of innovations related to depression and a second subset of the psychiatrists for evaluations of innovations related to schizophrenia, but does not rely on a third subset of the psychiatrists for evaluations of innovations related to either depression or schizophrenia. The first and second subsets of psychiatrists may or may not be overlapping.

In reference to the innovation decision process, the technical advice network is used in the second step of agreement/rejection. In determining whether to agree with or reject using an innovation, a member is already aware of the innovation from the first step of awareness. The member has not yet decided whether to agree with using the innovation or to reject using the innovation. To make this decision, the member uses agreement/rejection evaluations from those members in the technical advice network that influence the member. These influencing members of the technical advice network have evaluated the innovation and provide the member with the agreement/rejection evaluations of the innovation. If an agreement/rejection evaluation is for agreement, a member agrees with the use of the innovation, and if an agreement/rejection evaluation is for rejection, a member rejects the use of the innovation.

The trust and friendship network identifies the social structure and the communication structure in the target community that the members in the target community use for making optional innovation decisions. The trust and friendship network identifies the flow of evaluations on the adoption or non-adoption of innovations in the target community. For instance, a member relies on a first subset of members in the target community for providing evaluations of innovations in the target community, but does not rely on a second subset of members in the target community for providing evaluations on innovations in the target community. As an option, a member may have a different trust and friendship network for each technical advice network.

As an example, for a target community of psychiatrists, a trust and friendship network can be created that identifies which psychiatrists in the target community seek out for the evaluations of other psychiatrists in the target community on whether to adopt or not adopt an innovation. A psychiatrist in the target community relies on a first subset of the psychiatrists in the target community for providing evaluations of innovations in the target community, but does not rely on a second subset of the psychiatrists in the target community for providing evaluations of innovations in the target community.

The trust and friendship network is valuable to the change agent because it is through this communication structure that the social norms are created, changed, and maintained. The trust and friendship network removes the final layer of risk with adopting or not adopting an innovation and allows a member and/or the target community to adopt or not adopt an innovation.

In reference to the innovation decision process, the trust and friendship network is used in the third step of adoption. In determining whether to adopt or not adopt an innovation, a member has already decided to agree with using the innovation or to reject using the innovation. This decision was made using the technical advice network. The member has not yet decided to use or not use (i.e., adopt or not adopt) the innovation. To make this decision, the member uses adoption/non-adoption evaluations from those members in the trust and friendship network that influence the member. These influencing members of the trust and friendship network have evaluated the innovation and provide the member with the adoption/non-adoption evaluations of the innovation. If an adoption/non-adoption evaluation is for adoption, a member believes the innovation should be adopted, and if an adoption/non-adoption evaluation is for non-adoption, a member believes the innovation should not be adopted.

The influence network is obtained by combining the technical advice network and the trust and friendship network. The connections in the influence network do not differentiate between the technical advice network and the trust and friendship network and, instead, identify the flow of influence in the target community. Alternatively, the connections for the technical advice network and the trust and friendship network can be differentiated in the influence network.

In block 16, a sociogram is generated for the influence network. Using the results from blocks 13 and 14, a map of the influence network, called a sociogram, is created. As an option, sociograms are generated for each technical advice network and the trust and friendship network determined in block 15. The generated sociograms are provided on an information storage device for use by the change agent.

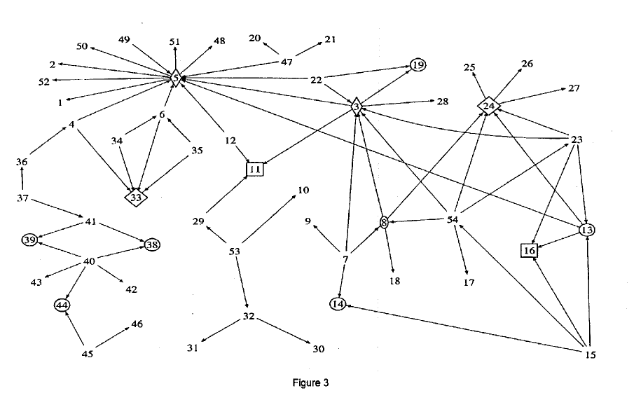

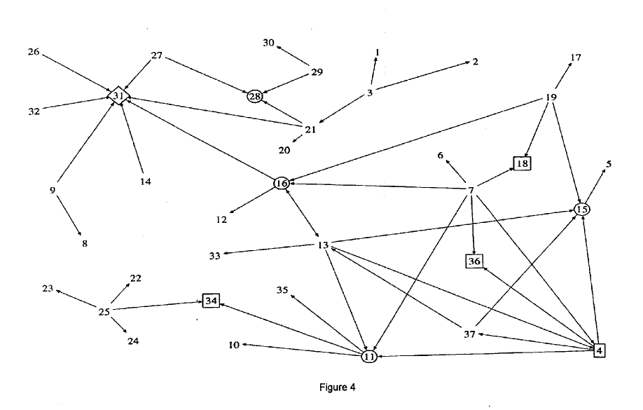

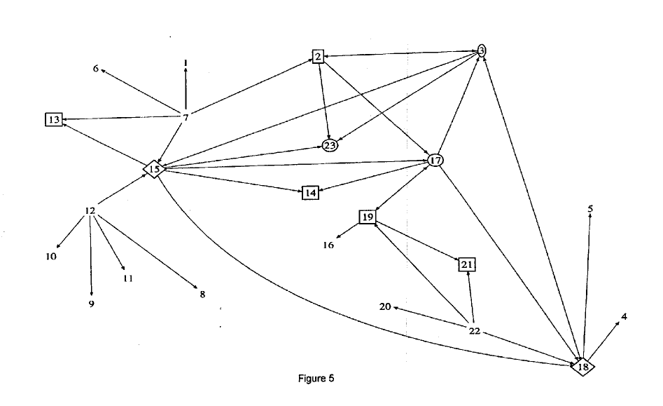

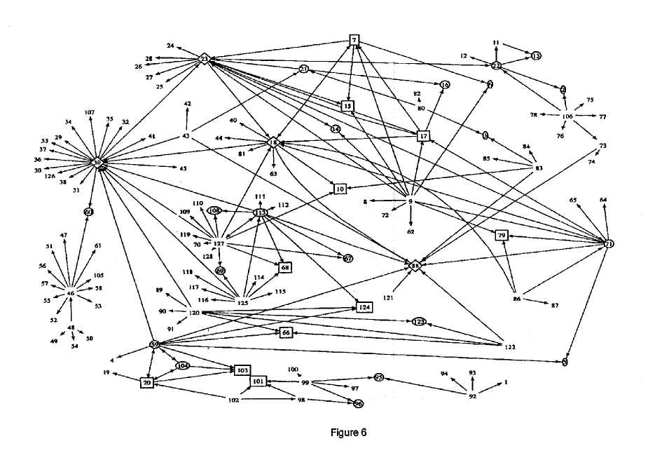

As an example, Figures 3-6 illustrate a family of sociograms for an influence network. Figure 3 illustrates a sociogram of a technical advice network for a first technical subject, namely depression, and Figure 4 illustrates a sociogram of a technical advice network for a second technical subject, namely schizophrenia. Figure 5 illustrates a sociogram of a trust and friendship network, and Figure 6 illustrates a sociogram of an influence network.

The target community for Figures 3-6 is the psychiatrists in southern Florida, and the completed questionnaires were analyzed to determine the influence network, the two technical advice networks, and the trust and friendship network. From the analysis, the members (i.e., psychiatrists) in the target community and their relationships were identified.

In Figures 3-6, the nodes in the networks are indicated with numbers, and the numbered nodes in each figure uniquely identify members in the target community. As an example, in Figure 5, 22 members are identified for the trust and friendship network, and there are 22 nodes in Figure 5. A table is created matching the number in the influence network with the name of the member, as well as other pertinent information, such as address, telephone number, telefax number, and electronic mail address. A numbered node in one figure does not necessarily represent the same member as the same numbered node in another figure.

In Figures 3-6, the connections in the network are lines that connect the nodes. The lines uniquely identify the social structure and the communication structure in the target community. A line connects one node to another node, and the two members corresponding to the two nodes are connected as part of the social structure and/or the communication structure in the target community. If two nodes are not connected with a line, the corresponding two members are not directly connected in either the social structure or the communication structure of the target community. For example, in Figure 5, the line from node 22 to node 18 indicates a social structure and/or a communication structure between the member represented by node 22 and the member represented by node 18. However, in Figure 5, the members represented by nodes 22 and 17 are not directly connected in either the social structure or the communication structure of the target community.

The arrow at the end of a line in Figures 3-6 indicates that the member represented by the node with the arrow has influence over the other member represented by the node without the arrow. If two nodes are connected by a line having an arrow at both ends, the members represented by the two nodes have influence over each other. Influence flows along a line in the opposite direction of the arrow. For two nodes connected by a line, the node without the arrow is known as the “in-degree” node, and the node with the arrow is known as the “out-degree” node. Influence flows from the “out-degree” node to the “in-degree” node.

As an example, in Figure 5, the line between nodes 22 and 18 has an arrow at node 18, and the member represented by node 22 indicated in the completed questionnaire that the member represented by node 18 had influence, in terms of trust and friendship, over the member represented by node 22. In addition, the member represented by node 22 indicated in the completed questionnaire that the members represented by nodes 19-21 also had influence, in terms of trust and friendship, over the member represented by node 22. Hence, four lines with arrows emanate from node 22 to nodes 18-21.

In the Figures 3-6, opinion leaders are identified by a graphical symbol around the number of the node. An opinion leader is determined to be a member having influence over two or more members of the target community. In terms of the sociograms, an opinion leader is represented by a node having two or more arrows into the node. In Figures 3-5, if a node has two arrows into the node, the node has a square, and if a node has three arrows into the node, the node has a circle or oval. In Figure 6, if a node has two arrows into the node, the node has a circle or oval, and if a node has three arrows into the node, the node has a square. In Figures 3-6, if a node has four or more arrows into the node, the node has a diamond. The more arrows into a node indicates that the member represented by the node has more influence in the target community.

For example, in Figure 5, nodes 13, 19, and 21 each have two arrows into the nodes, and the nodes have squares. Nodes 3, 17, and 23 each have three arrows into the nodes, and the nodes have circles or ovals. Nodes 15 and 18 each have four arrows into the nodes, and the nodes have diamonds. Because nodes 15 and 18 have the most arrows into the nodes, the members represented by nodes 15 and 18 have the most influence in the trust and friendship network than any other represented members. The remaining nodes have one or zero arrows and are not distinguished in the sociogram with graphical symbols.

In general, opinion leaders are identified in a sociogram using a threshold. An opinion leader is determined to be a member having influence over a number of members of the target community, where the number is greater than or equal to the threshold. For a sociogram, an opinion leader is identified as being represented by a node having a number of arrows into the node, where the number is greater than or equal to the threshold. For instance, in Figures 3-6, the opinion leaders are identified using a threshold of two, and each opinion leader is represented by a node having two or more arrows into the node. Depending on the social structure and communication structure of the target community, the threshold for determining opinion leaders can vary. For example, the threshold may be one, two, three, or more.

Using the completed questionnaires from the psychiatrists in southern Florida, the four sociograms were created: the technical advice network for depression of Figure 3, the technical advice network for schizophrenia of Figure 4, the trust and friendship network of Figure 5, and the influence network of Figure 6.

Two technical advice networks were able to be created because of the types of questions asked in the questionnaire. Some questions in the questionnaire were directed to determining the social structure and communication structure for transmitting information on depression, and some questions in the questionnaire were directed to determining the social structure and communication structure for transmitting information on schizophrenia.

Figures 3-6 do not have the same number of nodes because the respondents did not always answer each question or list the same number of members in response to the same questions. Further, when creating the sociograms, each member in the target community was not given a unique number. Instead, each member in the target community has a unique number for each sociogram, and a matching table is created for each sociogram. Alternatively, each member in the target community can be given a unique number.

The sociogram for the influence network of Figure 6 is generated from all responses from the completed questionnaires and is a combination of the sociograms of Figures 3-5. In general, the sociogram for an influence network incorporates the sociograms for the sub-networks of the one or more technical advice networks and the trust and friendship network and may include additional connections between nodes based on the responses in the completed questionnaires.

The lines and nodes in the sociogram for the influence network of Figure 6 do not differentiate between the technical advice network and the trust and friendship network and, instead, identify the general flow of influence in the target community. Alternatively, the lines and nodes for the technical advice network and the trust and friendship network can be differentiated in the sociogram for the influence network. For example, the lines and nodes for the technical advice network, the lines and nodes for the trust and friendship network, and the overlapping lines and nodes for both the technical advice network and the trust and friendship network can be differentiated by using various symbols and/or colors in the sociogram for the influence network.

Blocks 13-16 can be performed using a computer having software, where the software is embodied on a computer-readable medium. Using a computer and software, sociograms, such as those illustrated in Figures 3-6, can be created for the influence network, each technical advice network, and the trust and friendship network determined in blocks 13-16. The software uses as input information from the completed questionnaires received in block 12. For example, given the members in a target community identified in the completed questionnaires and given the relationships between the members in the target community from the completed questionnaires, the software automatically generates at least one sociogram. The one or more generated sociograms can be for the influence network, one or more of the technical advice networks, and/or the trust and friendship network of the target community. Preferably, the software is written in the C++ language and runs on a PC operating Windows.

With the sociogram for the influence network, the change agent is able to pursue a swift, efficient, and cost effective adoption of the innovation by the members in the target community. Referring back to block 2 in Figure 1, opinion leaders in the technical advice network are identified from the members in the target community. The technical advice network was determined as part of the influence network in block 1 and is related to the innovation, which the change agent is seeking to have adopted by the target community. By identifying the opinion leaders in the technical advice network, the change agent increases the efficiency of the adoption of the innovation by focusing marketing efforts on the opinion leaders for the technical advice network.

For example, using the sociogram for the technical advice network, such as in either Figure 3 or 4, the opinion leaders are visually identified as being represented by the nodes having a graphical symbol, namely a square, a circle or oval, or a diamond. Further, because multiple types of graphical symbols are used, the influencing power of the opinion leaders can be easily identified by the change agent.

The change agent recruits the opinion leaders of the technical advice network onto at least one panel. Preferably, all opinion leaders are on at least one panel, and especially the opinion leaders identified as being the most influential are on at least one panel. As an example, the panels can convene periodically, such as monthly, or at forums of the target community, such as professional functions, seminars, meetings, and conferences, or non-periodically whenever the change agent desires to persuade the target community to adopt an innovation.

For example, if the innovation is a new drug to treat depression, the technical advice network for depression illustrated in Figure 3 is used, and not the technical advice network for schizophrenia illustrated in Figure 4. Using the technical advice network for depression illustrated in Figure 3, the members represented by nodes 3, 5, 8, 11, 13, 14, 16, 19, 24, 33, 38, 39, and 44 are recruited onto panels, and especially the members represented by nodes 3, 5, 24, and 33 are recruited onto the panels as being the most influential members in the technical advice network for depression.

In block 3, the opinion leaders for the trust and friendship network are identified. Generally, the influence network has one trust and friendship network and one or more technical advice networks, and the trust and friendship network is used for all of the technical advice networks. By identifying the opinion leaders in the trust and friendship network, the change agent increases the efficiency of the adoption of the innovation by focusing marketing efforts on the opinion leaders for the trust and friendship network.

Continuing the above example, if the innovation is a new drug to treat depression, and if information on the new drug is dispersed according to the technical advice network illustrated in Figure 3, the opinion leaders in the trust and friendship network illustrated in Figure 5 are identified. Here, the opinion leaders are represented by nodes 2, 3, 13, 14, 15, 17, 18, 19, 21, and 23. The most influential opinion leaders in the trust and friendship network are represented by nodes 15 and 18, which are the only nodes with diamonds.

In block 4, the innovation is presented to the opinion leaders identified in block 2 for the technical advice network. The innovation is presented to the opinion leaders, instead of other members in the influence network, to increase the speed of the adoption of the innovation and to reduce the marketing costs by focusing on a much smaller group than that entire target community.

The change agent presents the innovation and information on the innovation to the panels of opinion leaders. For example, the presentation can include demonstrating the innovation, distributing samples of the innovation, distributing literature on the innovation, presenting clinical, trial, or test results using the innovation, and answering questions from the panel on the innovation. It is important for the change agent to enlist the opinion leaders of the technical advice network to at least “try out” the innovation.

Once an opinion leader has evaluated the innovation, the opinion leader forms an agreement/rejection evaluation of the innovation. As discussed above, with an agreement/rejection evaluation of agreement, an opinion leader agrees with the use of the innovation, and with an agreement/rejection evaluation of rejection, an opinion leader rejects the use of the innovation.

In block 5, the change agent assists with the dispersion of the agreement/rejection evaluations of the innovation to the members in the target community by using the technical advice network. Using the sociogram for the technical advice network as a guide, the change agent assists with the dispersion of the agreement/rejection evaluations of the innovation from the opinion leaders to the other members via the technical advice network. The agreement/rejection evaluations have a trickle-down effect from the opinion leaders to the other members in the technical advice network. In this manner, the agreement/rejection evaluations of the innovation cascade through the technical advice network in a very effective manner. Members learn of the innovation from those members that are respected for their technical advice. According to the innovation decision process, this is the second step of agreement/rejection.

As a result of this flow of agreement/rejection evaluations of the innovation via the technical advice network, members in the target community quickly learn about the agreement with or the rejection of the innovation. The agreement/rejection evaluations of the innovation may be communicated between members via the technical advice network by many techniques. Examples of techniques for communication of information on the innovation between members in the target community include: letters; electronic mail; telephone calls; personal visits; and discussions at forums for the target community.

To assist the process, the change agent maintains contact with the opinion leaders to ensure that agreement/rejection evaluations of the innovation are dispersed in a timely fashion and in an intentional and systematic manner. Using the sociogram of the technical advice network as a guide, the change agent facilitates the flow of the agreement/rejection evaluations through the technical advice network. Further, the change agent can send information on the innovation to the members in the technical advice network timed to the flow of the evaluations from the opinion leaders.

The change agent can assist in dispersing information on the innovation by making contact with the members in the target community, and especially the opinion leaders, as per the sociogram of the technical advice network. The change agent first focuses on the opinion leaders having the most influence, as determined by the sociogram for the technical advice network, and then focuses on the remaining opinion leaders in order of influence, as determined by the sociogram for the technical advice network. For example, the change agent can: send literature regarding the innovation to members in the target community; send samples regarding the innovation to members in the target community; send letters regarding the innovation to members in the target community using, for example, the letterhead of the change agent or the letterhead of the opinion leaders, with their approval; send electronic mail regarding the innovation to members in the target community; make telephone calls regarding the innovation to members in the target community; visit members in the target community to discuss the innovation; and attend forums for the target community to discuss the innovation with members in the target community.

In block 6, the change agent assists with the dispersion of the agreement/rejection evaluations of the innovation from the technical advice network to the opinion leaders of the trust and friendship network. The change agent assists in the interaction between the members of the technical advice and the opinion leaders in the trust and friendship network, and the change agent facilitates the “jumping” of information from the technical advice network to the trust and friendship network. The change agent identifies which members of the technical advice network influence the opinion leaders in the trust and friendship network. These relationships can be determined by examining the sociogram for the influence network or by comparing the sociogram for the technical advice network with the sociogram for the trust and friendship network. Once these relationships are determined, the change agent ensures that the agreement/rejection evaluations of the members in the technical advice network are communicated to the opinion leaders in the trust and friendship network.

With the agreement/rejection evaluations from the technical advice network, the opinion leaders in the trust and friendship network evaluate whether or not to adopt the innovation and form an adoption/non-adoption evaluation. As discussed above, with an adoption/non-adoption evaluation of adoption, an opinion leader believes the innovation should be adopted, and with an adoption/non-adoption evaluation of non-adoption, an opinion leader believes the innovation should not be adopted.

The change agent can assist the opinion leaders in evaluating whether or not to adopt the innovation using the techniques discussed above for block 5 for assisting in dispersing information on the innovation. The change agent first focuses on the opinion leaders having the most influence, as determined by the trust and friendship network, and then focuses on the remaining opinion leaders in order of influence, as determined by the sociogram for the trust and friendship network.

Continuing the above example, having identified the opinion leaders of the trust and friendship network illustrated in Figure 5, the change agent focuses on persuading these members. Foremost, the change agent focuses on persuading the member represented by nodes 15 and 18 because these members are identified in the trust and friendship network as having the most influence. By tracing the connections in Figure 5, the influence of these opinion leaders represented by nodes 15 and 18 can be seen to be great.

In block 7, the change agent assists with the dispersion of the adoption/non-adoption evaluations of the innovation to the members in the target community by the using the trust and friendship network. Using the sociogram of the trust and friendship network as a guide, the change agent assists with the dispersion of the adoption/non-adoption evaluations of the innovation from the opinion leaders to the other members via the trust and friendship network. The adoption/non-adoption evaluations of the innovation have a trickle-down effect from the opinion leaders to the other members in the trust and friendship network. In this manner, the adoption/non-adoption evaluations of the innovation cascade through the trust and friendship network in a very effective manner. Members receive adoption/non-adoption evaluations of the innovation from those members that are trusted and/or friends. Using the sociogram of the trust and friendship network as a guide, the change agent can assist in dispersing opinions on the innovation using the techniques discussed above for block 5 for assisting in dispersing information on the innovation.

Once the opinion leaders in the trust and friendship network have formed adoption/non-adoption evaluations, the other members in the trust and friendship network are influenced by the opinion leaders to adopt or not adopt the innovation in the same way as the opinion leaders. The influence flows through the target community as indicated by the trust and friendship network from the opinion leaders to the other members in the target community.

Once the adoption/non-adoption evaluations of the innovation are dispersed to the target community in block 7, each member begins to decide whether to adopt or not adopt the innovation according to the third step of adoption in the innovation decision process. In making this decision, members of the target community seek the opinion of the opinion leaders via the trust and friendship network.

In block 8, adoption or non-adoption of the innovation by the target community occurs. After and during the exertion of the influence by the opinion leaders in the trust and friendship network, each member decides to adopt or not adopt the innovation. After adoption or non-adoption of a significant number of the members of a target community has occurred, the target community is said to have either adopted or not adopted the innovation.

As an example of using the invention to market an innovation, the invention can be used for any target community in the healthcare industry and for any innovation in healthcare products and services. An example of target community in the healthcare industry is the group of psychiatrists in southern Florida. Examples of innovations in healthcare products and services include: a new drug; a new surgical device; new medical testing equipment; and a quality improvement program for a group of physicians or a hospital.

The invention has been described in detail with respect to preferred embodiments, and it will now be apparent from the foregoing to those skilled in the art that changes and modifications may be made without departing from the invention in its broader aspects, and the invention, therefore, as defined in the claims is intended to cover all such changes and modifications as fall within the true spirit of the invention.

1. A method for marketing an innovation to a plurality of members in a target community comprising the steps of:
determining with a computer an influence network for the plurality of members in the target community, said influence network mapping relationships between members in the target community, said influence network mapping at least a communication structure of the target community;
identifying with a computer opinion leaders from among the members in the influence network, each opinion leader having influence over other members in the target community, each opinion leader being identified based on a threshold amount of influence;
presenting the innovation to the opinion leaders, said presenting occurring after said determining and said identifying; and
assisting with dispersion of evaluations of the innovation from opinion leaders to the members in the target community by using the influence network.

2. A method as in claim 1, wherein the step of determining the influence network comprises the steps of:
providing questionnaires to members in the target community;
receiving completed questionnaires from the members; and
analyzing the completed questionnaires to map the influence network.

3. A method as in claim 1, wherein the step of determining the influence network comprises the steps of:
associating each member with a node in the influence network; and
determining connections between the nodes in the influence network using relationships between the members.

4. A method as in claim 1, wherein the step of determining the influence network comprises the step of determining at least one technical advice network and at least one trust and friendship network for the influence network.

5. A method as in claim 1, wherein the step of determining the influence network comprises the step of generating a sociogram of the influence network.

6. An information storage device embodying the sociogram of claim 5.

7. A method as in claim 1, wherein the step of presenting the innovation to the opinion leaders comprises the steps of:
recruiting the opinion leaders onto at least one panel; and
presenting the innovation to the at least one panel of opinion leaders.

8. A method as in claim 1, wherein the step of assisting with dispersion of evaluations of the innovation includes at least one of the steps of: sending literature regarding the innovation to members in the target community; sending samples regarding the innovation to members in the target community; sending letters regarding the innovation to members in the target community; sending electronic mail regarding the innovation to members in the target community; making telephone calls regarding the innovation to members in the target community; visiting members in the target community to discuss the innovation; or attending forums for the target community to discuss the innovation with members in the target community.

9. A method as in claim 1, wherein the innovation is at least one of a healthcare product or a healthcare service.

10. A method as in claim 1, wherein the members in the target community are healthcare providers.

11. A computer having software for performing the step of claim 1 of determining the influence network.

12. A computer-readable medium having software for performing the step of claim 1 of determining the influence network.

13. A method for marketing an innovation to a plurality of members in a target community comprising the steps of:
receiving at least one sociogram for an influence network for the plurality of members in the target community, said influence network mapping relationships between members in the target community, the influence network comprising at least one technical advice network for members in the target community and a trust and friendship network for members in the target community;
identifying with a computer opinion leaders from among the members in at least one of the technical advice networks, each opinion leader having influence over other members in the target community;
identifying with a computer opinion leaders from among the members in the trust and friendship network;
presenting the innovation to the opinion leaders of the technical advice network;
assisting with dispersion of evaluations of the innovation from the opinion leaders of the technical advice network to the members in the target community using the technical advice network and at least one of the sociograms;
assisting with dispersion of evaluations on the innovation from members in the technical advice network to the opinion leaders of the trust and friendship network using the technical advice network, the trust and friendship network, and at least one of the sociograms; and
assisting with dispersion of evaluations of the innovation from the opinion leaders of the trust and friendship network to the members in the target community using the trust and friendship network and at least one of the sociograms.

14. A method as in claim 13, further comprising the steps of:
providing questionnaires to the members in the target community;
receiving completed questionnaires from the members;
associating each member in the completed questionnaires with a node in the influence network;
determining connections between the nodes in the influence network using the completed questionnaires;
determining the technical advice network and the trust and friendship network for the influence network; and
generating the at least one sociogram for the influence network.

15. A computer having software for the performing the steps of claim 14 of associating each member, determining connections, determining the technical advice network and the trust and friendship network, and generating the at least one sociogram, wherein the software uses as input information from the completed questionnaires.

16. A computer-readable medium having software for performing the steps of claim 14 of associating each member, determining connections, determining the technical advice network and the trust and friendship network, and generating the at least one sociogram, wherein the software uses as input information from the completed questionnaires.

17. A method as in claim 1, wherein the step of determining the influence network comprises the step of obtaining information from members in the target community regarding relationships between members in the target community.

18. A method as in claim 17, wherein the information regarding relationships between members in the target community comprises information regarding a social structure and a communication structure of the target community.

19. A method as in claim 1, wherein the members in the target community are from a plurality of organizations.

20. A method as in claim 13, wherein the innovation is at least one of a healthcare product or a healthcare service, wherein the members in the target community are healthcare providers, wherein the members in the target community are from a plurality of organizations.
